(19) United States
(12) Patent Application Publication
(10) Pub. No.: US 2006/0031193 A1
(43) Pub. Date: Feb. 9, 2006

(54) Data searching method and information data scrapping method using internet

(76) Inventors: Jeong-Bum Pyun, Goyang (KR); Won-Jun Park, Goyang (KR)

Correspondence Address: CANTOR COLBURN, LLP, 55 GRIFFIN ROAD SOUTH, BLOOMFIELD, CT, 06002, US

(21) Appl. No.: 10/535,003

(22) PCT Filed: Oct. 31, 2003
(86) PCT No.: PCT/KR03/02323

§ 371 Date: May 12, 2005

(30) Foreign Application Priority Data
Nov. 12, 2002 (KR) 10-2002-0070187

(51) Int. Cl. G06F 17/30

(52) U.S. Cl. 707/3

(57) ABSTRACT

A data search method comprises a search condition input step inputting search condition through a user terminal connected to an electric communication network; and a batch processing search step for performing search in a batch processing, wherein the batch processing step includes: a transmission subroutine for transmitting the search condition to one or more database servers having search engines through the electric communication network, a first reception subroutine for receiving one or more search condition through the electric communication network, and a second reception subroutine for receiving data associated with the search results through the electric communication network.

### TECHNICAL FIELD

The present invention relates to a data search method and, more particularly, to a data search method for searching data through information communication, in particular, the Internet.

### BACKGROUND ART

With the development of the computer technology, the electric communication network represented by the Internet has made an influence on the entire society. Most of things occurred off-line have transferred to the Internet, i.e., online world such that the Internet has become another life.

For instance, generally, information must be collected from literatures, newspapers, magazines, etc. at a library.

However, it became possible to easily collect information by only inputting keywords associated with the information to find out through the computer or the terminal connected to the Internet nowadays.

The general online data search and collection will be described in detail hereinafter with reference to FIG. 1.

Firstly, a user accesses a web site (for example, a newspaper site, a magazine site, or a database site having a search engine) through a user's terminal at step S1. Here, the access means to establish connection to the web site through which to perform search. Once the connection to the desired site is established, the user inputs keywords associated with the contents to find out at step S2. That is, the user inputs the keywords in a key word input box. If the search is completed at step S2, a list showing the search results is displayed on a screen of the user terminal.

At step S4, the user checks the contents of the data linked to the list by clicking an item of the list displayed on the screen of the user terminal. In such a situation, the user can refer to the respective data by randomly clicking any one of the items on the list or clicking a relevant item. The user determines whether or not the item contains the contents he wants to find out by reading the contents of the data linked to the clicked item at step S5. If the item contains the information he wants to find out, the user copies the content using an input device such as a keyboard or a mouse at step S6. The copied contents are pasted using a word processor such as Hangul or MS word in the form of text so as to be edited by the user at step S7.

These procedures, i.e. step S4 to step S7, are repeatedly performed in order. By doing this, the user can collect the information he wants, and edit the collected information as he wants. At step S8, then it is determined, by the user's intention, whether or not there are contents to be checked. And then, it is determined whether or not to do the same operation at other search site at step S9. Consequently, the information collection operation is terminated if it is not required to search the information at other sites.

In this manner, the data taken through the above procedure are stored as image or text files and managed, if it is required, using the word processor with which the user is familiar.

However, there are some problems in this data collect operation. Among them, a critical problem is that it takes so long time for the data collect operation. In fact, the time being elapsed for the online search, in consideration of presently wide spread ADSL environment or superior, is long, i.e. about 5˜10 seconds for access to the search site, about 5˜10 seconds for keyword input, about 2˜20 seconds for waiting the results (including loading additional information such as various advertisements, associated link, or selection window), about 3˜5 seconds for selecting and clicking a specific item, about 10˜20 seconds for checking whether or not the contents of the selected item is useful, about 10 seconds for selecting and copying the contents if it is useful, and about 5 seconds for pasting the copyed contents as a word processor document.

As described above, it takes so long time for the user to collect the information through the user terminal according to the conventional procedures. One reason of the time consuming is that the human, the network, and the user terminal are functionally mixed such that it takes long time for changing the main body of the operation. That is, the operation is performed in an order of user's manipulation→waiting for access to the target site through the network→user's manipulation→operation of the terminal→user's decision→user's manipulation, etc.

Also, the second reason of the time consuming is that it takes long time to completely load a web page containing about 40˜50 useless advertisements, links, or images as well as the useful data for identifying the contents. Furthermore, this procedure should be repeatedly performed whenever the user tries to search the data at other sites.

Also, the conventional repeated information collecting procedure has shortcomings in that it makes the user feel tedious as well as waste much time.

Also, some useful information can be missed or duplicated during the repeated procedures. In this case, unnecessary operation for searching the omitted information may be performed again. Also, these recursive operations make the user uncomfortable if it is repeated frequently or daily.

Recently, metaengine softwares have been developed such that the above problems are solved to some extent. However, these softwares mearly show the functional level gathering the search results in one place. That is, the softwares provide the services to display only the Uniform Resource Locators (URL: which is a form uniformly representing the resource addresses for accessing over the Internet) associated with the search results.

The Korean Laid-Open Patent 10-2001-10807 No. discloses a news information scrap method and system using the Internet, in which the interesting information such as articles of news papers, public announcements, advertisements, etc. with the sources are retrieved in forms of image and text files through the Internet and the search results are stored in a database storage space for the user.

In this technique, however, it is required for the user to access and retrieve the search results from the storage space of the database in which the search results are stored when the user intends to see the scrapped information. This requires a unique server for the user.

Also, either of the Korean Laid-Open Patent Nos. 10-2001-102786 and 10-2002-26082 discloses service for classifying, editing, and retrieving information in storage space such as scrap server, database, or the like, in that the information collected and edited in the server or database can be retrieved through the Internet. However, this technique has a shortcoming in that the collected information cannot be read in an off-line state.

### DISCLOSURE OF INVENTION

To solve the above problems, it is an object of the present invention to provide a data search method capable of dramatically reducing the time required for collecting information.

It is another object of the present invention to provide a data search method capable of efficiently collecting, analyzing, and managing the data searched through an electric communication network, i.e., the Internet.

To achieve the above objects, the data search method according to the present invention comprises a search condition input step inputting search condition through a user terminal connected with an electric communication network; and a batch processing search step for performing search in a batch processing, wherein the batch processing step includes: a transmission subroutine for transmitting the search condition to one or more database servers having search engines through the electric communication network, a first reception subroutine for receiving one or more search results searched by the search engines of the database servers according to the search condition through the electric communication network, and a second reception subroutine for receiving data associated with the search results through the electric communication network.

Also, the present invention provides a computer program capable of executing the above data search method.

Also, the present invention provides a storage medium for storing the above computer program.

Also, the present invention provides a method for transmitting or receiving the above computer program through an electric communication network.

Also, the present invention provides a method for scrapping information data using the Internet which comprises the steps of searching target information by inputting keywords using a search function of a search site through a user computer with online connection; accessing a web server of the search site through an HTTP protocol automatically set at the user computer; transmitting a query for searching at the web server of the connected search site; transmitting one or more search results retrieved at one or more database servers as results of the query which is received by the web server; downloading the searched data through the HTTP protocol; removing unnecessary data among the downloaded data; storing the data remained after the unnecessary data are removed; editing, processing, and managing the data stored in a local storage medium using a program included in the user computer.

### BRIEF DESCRIPTION OF THE DRAWINGS

FIG. 1 is a flowchart illustrating a conventional data search method through the Internet.

FIG. 2 is a block diagram illustrating a data search system according to the present invention.

FIG. 3 is a flowchart illustrating a data search method according to the first embodiment of the present invention.

FIG. 4a is a flowchart illustrating a server adding process of the search condition input step of the data search method in FIG. 3.

FIG. 4b is a flowchart illustrating a batch processing search of the data search method in FIG. 3.

FIG. 5 is a flowchart illustrating a data scrap method according to the second embodiment of the present invention.

FIG. 6 is a flowchart illustrating a stored data management process of the data scrap method in FIG. 5.

FIG. 7 is a conceptual view illustrating a window for displaying a program for executing the data search method and data scrap method according to the present invention.

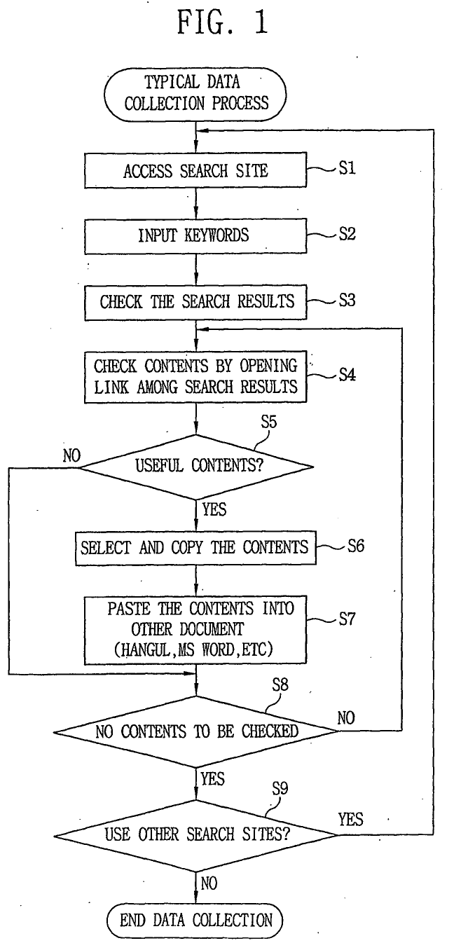

### BEST MODE FOR CARRYING OUT THE INVENTION

The data search method and the data scrap method using the Internet according to the present invention will be described hereinafter with reference to the accompanying drawings.

To achieve the objects of the present invention, firstly, a function of a batch processing for search is required in that the search is performed at several search sites and the search results are shown at one sight. Secondly, a function for processing the search results such that the unnecessary data such as various banners and advertisements that delay loading of contents and cause problems for storing and managing the useful contents. Thirdly, it is required to quickly identify the contents even when the many results are searched so as to enhance the speed of data retrieval. That is, in case that thousands of search results should be inspected, it takes a few seconds for inspecting each of search results in conventional data search technique, thus increasing time consumption. It is required to quickly inspect the contents of the search results. Fourthly, it is required to facilitate the data management such that the identified contents be easily managed. That is, the contents should be stored if those are useful, and on the other hand, the useless contents can be easily removed. Also, the stored contents should be easily converted into a word processor document format. Fifthly, an automatic update function is required in that the searched contents are periodically and automatically updated by user's intension. Since recently the information rapidly changes, the stored information contents should be periodically updated so as to maintain the value of the information. This increases the temporal, physical, and mental satisfactions of the user.

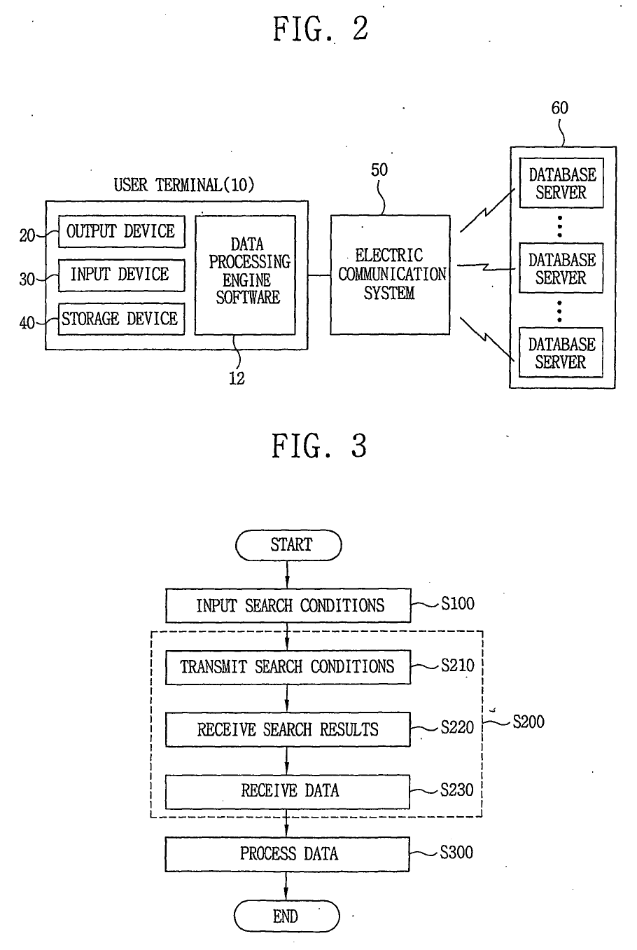

FIG. 2 is a block diagram illustrating a system for the data search method and data scrap method according to the present invention, in which a data processing engine software installed in a local user terminal (personal computer), etc. connected to the Internet accesses a web server through the Internet so as to collect the search results and store the search results in a local storage medium (floppy disc, hard disc, compact disc, flash memory, etc.).

The user terminal 10 is a portable terminal such as a desktop computer, a portable computer, a personal digital assistants (PDA), a mobile handset, etc. that can perform online communication through an electric communication network, such as the Internet. At the user terminal 10, a data processing engine software 12 should be installed. The data processing engine software 12 may be a freeware, a shareware, or a pay software as an engine having functions searching data through the Internet and storing the data. Also, the data processing engine software has a function converting the files downloaded and stored in a local storage medium into one or more files and storing the converted files. The data processing engine software 12 is a computer program for executing the data search method and the data scrap method according to the present invention.

An output device 20 is a device such as a monitor for displaying searched data or input/output status of the input/output devices. An input device 30 is a device such as a keyboard and a mouse for inputting search keywords and editing the searched results.

A storage device 40 is a floppy disc (FD), a hard disc drive (HDD), a compact disc (CD), or a flash memory for storing the data processing engine software 12 and the searched data, etc.

A web server or a database server 60 is a server for a web site, such as newspaper or magazine site for providing various informations, which is connected to the local user terminal 10 through the electric communication network, i.e., the Internet 50. The database server 60 may be associated with a plurality of sub-database servers providing various data such as images and other informations. The database server 60 may preferably include a search engine for searching data. The data stored in the database server 60 may be intellectual property information related to patents (utility models), designs, trademarks, copyrights, etc., an internet shopping malls (price information, products information), as well as newspapers and magazines.

The data search method according to the first embodiment of the present invention, as depicted in FIG. 3, comprises a search condition input step S100 inputting search condition through a user terminal 10 connected to an electric communication network 50; and a batch processing search step performing search in a batch processing, wherein the batch processing step includes: a transmission subroutine S210 for transmitting the search condition to one or more database servers 60 having search engines through the electric communication network 50, a first reception subroutine S220 for receiving one or more search results searched by the search engines of the database servers according to the search condition through the electric communication network 50, and a second reception subroutine S230 for receiving data associated with the search results through the electric communication network.

The search condition input step S100 may further include a server selection step S110 for selecting the database server.

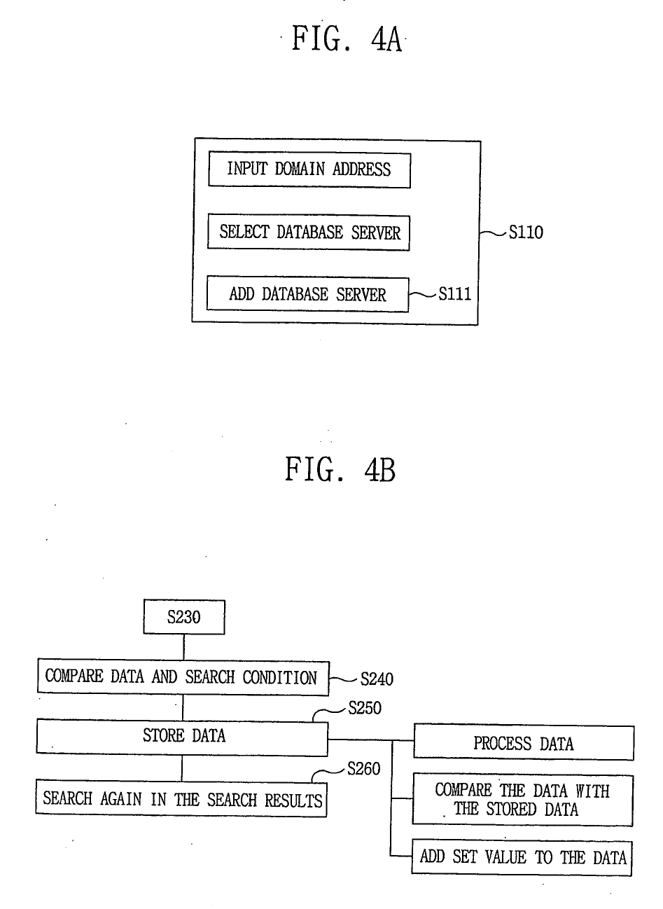

Also, in the server selection step S110, as depicted in FIG. 4a, a domain address of the database server 60 or selecting one or more database servers 60 from a server list, may be directly inputted.

Also, the server selection step S110 may further include a server adding step S111 for adding the database servers 60 to the server list. The database server list may be stored as an additional file, communicated between the users, and periodically updated.

The database server 60 may be selected using the server selection box or the server selection popup menu.

The search condition may be inputted identical with the search engine input condition of the database server 60 so that the user may easily input the search condition for search. Particularly, in case of database server requiring a specific form, the search condition may be inputted in the form identical with the form required by the search window of the database server 60.

The search condition may be a keyword such as in the form of a word or a sentence and may include temporal attributes so as to perform a specific search.

Also, the search condition may include a transmission search condition, which is transmitted to the search engine of the database server 60; and a required-data condition given to the data received at the second reception subroutine S230.

The transmission search condition is the search condition used in the database server 60, and the required-data condition is the search condition for selecting and processing the data searched by the database server 60. Also, the required-data condition may be keywords capable of classifying the searched data, i.e. searching again in the search results S260.

The required-data condition may be a file type, a creation date, a text document without image, or the like that the user may optionally set.

The input type or form may differ from each other according to the database servers. The transmission subroutine S210 may further include a conversion subroutine for converting the inputted search condition into a form required by the search engine of the database server 60 such that the inputted search condition is converted into one which each database server 60 requires for user's convenience. Of course, the conversion subroutine may be preferably updated according to the status change of the corresponding database server 60.

The batch processing search step S200, as shown in FIG. 4b, may further include a comparison/decision subroutine (S240) for determining whether or not the data received at the second reception subroutine (S230) satisfies the search condition inputted at the search condition input step.

The batch processing search step S200 may further include a data storage subroutine S250 for storing the data received at the second reception subroutine S230 in the user terminal.

In the data storage subroutine S250, the data received at the second reception subroutine S230 is stored after being processed or the advertisement parts of the data being removed. Also, in the data storage subroutine S250, the data received at the second reception subroutine S230 may be stored after being edited in view of online attributes so as to be off-line used.

In the data storage subroutine S250, it is preferred that the received data is stored in the user terminal 10 when the data differ from the previously stored data after being compared with each other and determined as such so as to prevent the duplicate data from being stored.

Also, in the data storage subroutine S250, the data received at the second reception subroutine S230 may be stored after a predetermined value, information on the database server which transmits the data, and a copyright of the data being added thereto.

On the other hand, the data search method according to the present invention may further comprise a processing step S300 for processing the data stored in the user terminal 10 after the batch processing search step S200.

In the processing step S300, the received data are processed as being converted into an identical form, combined as one file, or edited according to the user-required condition.

The batch processing step S200 is repeatedly performed at preset time intervals or in real time for reflecting changes in the data such as the data being searched again or changed.

The search condition of the data search method according to the present invention may be set to include log-in information so as to access the database server requiring log-in process when the database server 60 requires the log-in process.

The database server 60 may include an intellectual property database, an internet shopping mall database, an article database for newspapers and magazines.

The database search method according to the present invention may further include a web page displaying step for displaying a web page corresponding to a selected address. Also, the web page displaying step may further include a favorite registration step for storing the address of a user's favorite web page or an address input step for inputting the address of the web page.

Particularly, with the web page displaying step, the user may search the web page which the user wants to access together with a data search and collection so as to increase the user's operation efficiency. Also, it is possible to directly access the database server 60 with the address of the database server.

The database search method according to the present invention may be executed as a computer program capable of being executed in a computer, a portable terminal, etc. The computer program may be stored in various storage media such as a hard disc drive (HDD), a floppy disc (FD), a flash RAM, a CD, a DVD, etc. and may be transmitted to and received from the user's terminals or servers through the electric communication network.

On the other hand, the basic background technology of the second embodiment of the present invention is a screen scrapping. Here, the screen scrapping is a technique which reads the contents of the Internet web site and extracts intended information from the contents.

For instance, with the screen scrapping, it is possible to read weather information from a weather information provider site, articles from a news provider site, and securities information from a securities information provider site so as to use the information.

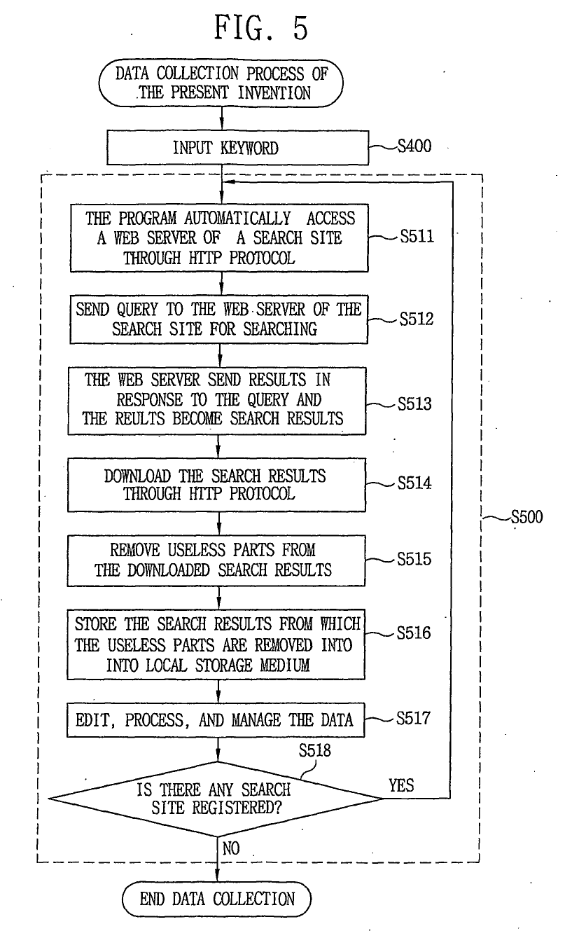

A data search and connection procedure executed based on the screen scrapping function according to the second embodiment of the present invention will be described with reference to FIG. 5.

At step S400, a search is performed by inputting keywords for various intended informations using the search function of the search site (for example, various information provider sites such as a newspaper site, a daily or a monthly magazine site) accessed by the user terminal 10 connected online. For example, using the search function of the newspaper site providing the news information through the online connection, the intended contents are searched. At this time, it is possible to provide an integral search function that can perform searching several sites at once using identical keywords.

After the step S400, the batch processing search step S500 installed in the user terminal performs the following steps in a lump.

At step S511, the user terminal 10, as it is configured with a program, is automatically connected to the database server 60 of the search site through the Internet with HTTP protocol.

The Hypertext Transfer Protocol (HTTP) is an application protocol associated with a Transmission Control/Internet Protocol (TCP/IP) required for communicating files (text, graphic image, sound, video, and other multimedia files) over the web.

The user terminal transmits a search query to the database server of the search site at step S512 and the database server 60, in response to the search query, transmits the search results retrieved from one or more database servers associated therewith to the user terminal 10.

The user terminal reads the actual contents using the received search results. That is, because most of the search results are Hyperlinks connected to the actual contents. Accordingly, the method of present invention performs reading the actual contents using the searched link information. During the reading operation, the screen scrapping technique is used. That is, the user terminal analyzes the links connected to the actual contents using the screen scrapping technology. At step S514, the searched data is downloaded by using the HTTP protocol.

At step S515, from the downloaded information, unnecessary information is removed. During this process, the read information is converted into an appropriate form. The conversion to the appropriate form is performed through following processes.

By removing the unnecessary information, various advertisement information and unwanted links are removed, and the images associated with the information the online links thereof are converted into off-line links. At this time, the link conversion is carried out as follows.

A name of the actual image is extracted. For example, in case of a link http://www.test.com/test.jpg, the file name “test.jpg” is extracted. And then a relative location of the image is added as a prefix of the name of the image. At this time, the relative location may be a folder named “img”. That is, the file test.jpg has an off-line link img/test.jpg. And, the image file at the fixed link is downloaded into the “img” folder. In this manner, the local data including the image can be created.

Also, the various HTML links are added as necessary information. During the unnecessary information removal process, it is possible to remove the prefix and suffix of the link so as to remain the middle part of the link. In some cases, the necessary tags, for example, the <html> tag representing HTML document may be removed. So this important tag information is added.

At step S516, the data from which the unnecessary information is removed, is stored in a local storage device 40. That is, the processed information is stored in the local storage device 40 and the actual contents are stored as in the form of individual files. And the link information is stored in the database. By separating the contents from links, the search speed is enhanced. Also, it is possible to minimize the damage when a problem occurs in the database. Also, the individual files may be used independently.

At step S517, the information stored in the local storage device 40 is edited, processed, and managed by a program installed in the user terminal 10.

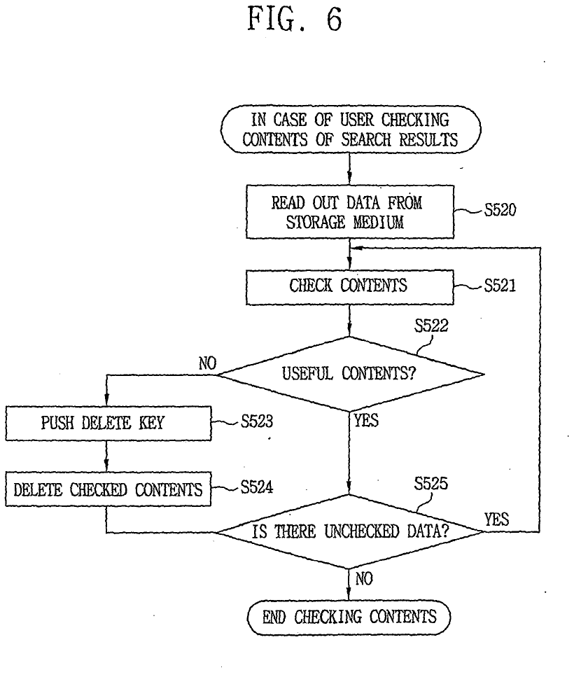

FIG. 6 is a flowchart illustrating a process managing the information stored in the local storage device 40, at step S517. That is, the information stored in the local storage device 40 is read at step S520. Then, the contents of the read information are checked at step S521 and determined whether or not it is intended one at step S522. If the contents are unnecessary, they are removed by using a removal key of the input device 30 as at step S523 and S524. On the other hand, if the contents are the intended one, it is determined whether or not there is unchecked information at step S525. The contents checking procedure of steps S522 to S525 is repeatedly performed.

On the other hand, it is determined whether or not to search other registered search sites at step S418 and the steps S411 to S417 are repeatedly performed.

The processing order of the step S417 and S418 may be changed according to the user's intention. After the data stored in the storage medium is processed, it is possible to search other registered search sites and then process the data stored in the storage medium.

The information stored during the above processes may be easily managed by the user with the removing and combining functions and the stored information may be easily stored and retrieved into and from other storage media with a backup function. Also, the information associated with a designated keyword may be automatically updated at predetermined intervals, for user's convenience.

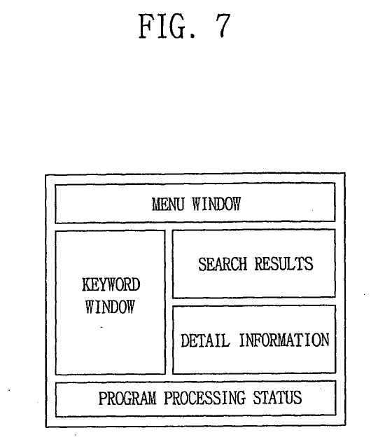

FIG. 7 shows a main screen of a program according to the present invention, in which the keywords selected by the user are listed on the left side, search results corresponding to a specific keyword such as a title, a newspaper company, a weather, etc. are displayed on the top right side, and detail information such as titles and related contents of the article is displayed on the bottom side.

And on the bottom of the main screen, a window displaying a program execution status is displayed. The program execution status includes a whole search status, a present site search status, a present site storage status, a present site, a number of data searched, etc.

And, it is possible to register a search keyword together with a search target, search period, etc. The registered keyword may be removed and recovered according to the user's intention.

The information search program according to an embodiment of the present invention can be utilized for a newspaper, for example Chosunilbo web site, and shows the result as follows.

The search program showed the efficiency improvement, in the time taken to search, of more than 500% search efficiency compared with that of the conventional search method in that the search operation is carried out by accessing the website, retrieving, and checking the contents. Particularly, the search method of the present invention has showed the better efficiency when the number of search results increases.

The search method is tested in an environment in that the user computer has been running with the operating system of Windows 2000® and connected to the Internet through a high-speed digital subscriber line (xDSL).

When the search is performed with a keyword “changup” in Korean Language, about 6000 search results are retrieved. If these search results are checked with the conventional search method, the time taken to check will be 5 seconds per each and the total 5 seconds×6000=8.3 hours.

And the time taken to copy and store the intended data becomes 3˜4 times longer. Accordingly, at least more than 20 hours will be taken.

However, in case that the data processing engine software of the present invention, the time taken to process the 6000 search results is about 20˜30 minutes (the time may change according to the status of high speed Internet) and the checking time become 1.5 seconds per each and 2 hours and 30 minutes in total. Furthermore, since the checking, removing, storing processes are performed at the same time; there is no additional time for copying and storing the data. Accordingly, the total time required for the whole search process will become about 3 hours.

Objectively, the data search method of the present invention shows superior temporal efficiency of 3 hours to the 20 hours of the conventional search method, i.e. improvement over 600% of temporal efficiency.

Also, in the present invention, other operations can be performed during the search operation such that the actual time taken for search can be much shorter than ever.

### INDUSTRIAL APPLICABILITY

As described above, the information scrapping method using the Internet according to the present invention is practical in various fields and objects and can be efficiently utilized for researching and storing data regarding to the own brand products, competitor products, and market trends at the planning and sales promotion departments of businesses. Also, the information scrapping method can be practically used by a sales department for researching and storing the information on the client companies, the business trends, and personnel, and also can be used for researching the business related information by an individual who are planning to start business. Also, the method can be used by a stock investor for gathering information on the stocks, he owns, such as business news and trend of the company related to the stocks and the general trend of the industry.

Also, in case of a student, the information scrapping method can be utilized for collecting various reports and articles or photographs of entertainers he/she likes and for collecting the data related to his hobbies and health.

Furthermore, according to the present invention the web documents searched by the data processing engine software can be compressed in a minimal form and then stored in the local storage medium such that it is possible to retrieve the stored data regardless of the online connection and minimize the time required for searching and checking the data. Also, since the data are stored after being minimized in size it is easy to manage the data by deleting and combining the same.

1. A data search method comprising:
a search condition input step inputting search condition through a user terminal connected to an electric communication network; and
a batch processing search step performing search in a batch processing,
wherein the batch processing step includes: a transmission subroutine for transmitting the search condition to one or more database servers having search engines through the electric communication network,
a first reception subroutine for receiving one or more search results searched by the search engines of the database servers according to the search condition through the electric communication network, and
a second reception subroutine for receiving data associated with the search results through the electric communication network.

2. The method of claim 1, wherein the search condition input step further includes a server selection step for selecting the database server.

3. The method of claim 2, wherein, in the server selection step, a domain address of the database server is directly inputted.

4. The method of claim 3, wherein, in the server selection step, one or more database servers from a server list are selected.

5. The method of claim 3, wherein the server selection step further includes the step for adding the database servers to the server list.

6. The method of claim 1, wherein, in the search condition input step, the search condition is inputted corresponding to the input condition required for the search engine of the database server.

7. The method of claim 1, wherein the search condition is keywords.

8. The method of claim 1, wherein the search condition includes time attributes.

9. The method of claim 1 or 6, wherein the search condition includes:
a transmission search condition that is transmitted to the search engine of the database server; and
a required-data condition given to the data received at the second reception subroutine.

10. The method of claim 9, wherein the required-data condition includes file type and a creation date of the data.

11. The method of claim 1, wherein the transmission subroutine further includes a conversion subroutine for converting the inputted search condition so as to have a type required for the search engine of the database server.

12. The method of claim 1, wherein the batch processing search step further includes a comparison/decision subroutine for determining whether or not the data received at the second reception subroutine satisfy the search condition inputted at the search condition input step.

13. The method of claim 1, wherein the batch processing search step further includes a data storage subroutine for storing the data received at the second reception subroutine in the user terminal.

14. The method of claim 13, wherein, in the data storage subroutine, the data received at the second reception subroutine, is stored after being processed.

15. The method of claim 13, wherein, in the data storage subroutine, the data received at the second reception subroutine, is stored after being removed an advertisement part from the received data.

16. The method of claim 13, wherein, in the data storage subroutine, the data received at the second reception subroutine, is stored after being editing online elements from the received data so as to be used in off-line.

17. The method of claim 13, wherein, in the data storage subroutine, the received data, is compared with the previously stored data and is stored when the received data differs from the previously store data.

18. The method of claim 13, wherein, in the data storage subroutine, the data received at the second reception subroutine is stored after being added a presset value.

19. The method of claim 18, wherein, in the data storage subroutine, the data received at the second reception subroutine, is stored after being added database server information associated with the database server transmitted the data and copyright information of the data.

20. The method of claim 1, further comprising a processing step for processing the data stored in the user terminal after the batch processing search step.

21. The method of claim 20, wherein the data is converted to an identical form at the processing step.

22. The method of claim 20, wherein the received data is combined as one file in the processing step.

23. The method of claim 1, wherein the batch processing step is periodically repeated at preset time intervals.

24. The method of claim 1, wherein the batch processing step is repeated in real time.

25. The method of claim 1, wherein the search condition includes log-in information for accessing the database server requiring a log-in process.

26. The method of claim 1, wherein the database server is an intellectual property database server.

27. The method of claim 1, wherein the database server is an Internet shopping mall database server.

28. The method of claim 1, wherein the database server is an article database server.

29. The method of claim 1, further comprising a web page display step for displaying a web page corresponding to the selected domain address.

30. A computer program being executable in accordance with the methods of claim 1.

31. A storage medium for storing the computer program of claim 30.

32. A method for transmitting and receiving the computer program of claim 30 through an electric communication network.

33. A method for scrapping using the Internet comprising:
searching target information by inputting keywords using a search function of a search site through a user computer with online connection;
accessing a web server of the search site through an HTTP protocol automatically set at the user computer;
transmitting a query for searching at the web server of the connected search site;
transmitting one or more search results retrieved at one or more database servers as results of the query which is received by the web server;
downloading the searched data through the HTTP protocol;
removing unnecessary data among the downloaded data;
storing the data remained after the unnecessary data are removed;
editing, processing, and managing the data stored in a local storage medium using a program included in the user computer.

34. The method of claim 33, wherein the program (data processing engine software) of the user computer automatically and periodically updates the data associated with a search word designated by the user.

35. The method of claim 33, wherein the unnecessary data is various advertisements data and unnecessary links.

36. The method of claim 33, wherein image data link conversions are performed in such a way that in case of images associated with the contents the online links are converted into off-line links.

37. The method of claim 33, wherein the searched data is any one of online newspaper, magazine, and web document.

38. The method of claim 33, further comprising the step of minimizing storing time and space by removing the unnecessary tag parts and storing necessary parts from the downloaded data.

39. The method of claim 33, wherein the program (data processing engine software) included in the user computer automatically converts the contents of the downloaded and stored HTML document for using the additional data such as images at the local storage medium.

40. The method of claim 33, wherein the program (data processing engine software) included in the user computer converts the files downloaded and stored in the local storage medium into one or more files and then stores the same.

41. The method of claim 33, wherein the local storage medium is any one of a floppy disc, a hard disc, a compact disc, and a flash memory.
